(19) United States
(12) Patent Application Publication
(10) Pub. No.: US 2004/0080844 A1
(43) Pub. Date: Apr. 29, 2004

(54) Structure of color elements for a color filter

(75) Inventors: Hsin-An Cheng, Hsinchu (TW); Kuang-Lung Kuo, Junli City (TW); Sheng-Shiou Yeh, Miaoli (TW); Tzu-Seng Yang, Hsinchu (TW)

Correspondence Address: QUINTERO LAW OFFICE, 1617 BROADWAY, 3RD FLOOR, SANTA MONICA, CA, 90404, US

(73) Assignee: Toppoly Optoelectronics Corp.

(21) Appl. No.: 10/412,107

(22) Filed: Apr. 11, 2003

(30) Foreign Application Priority Data
Oct. 25, 2002 (TW) 91125212

(51) Int. Cl. G02B 5/22

(52) U.S. Cl. 359/885; 359/891

(57) ABSTRACT

A structure of color elements for a color filter. At least a first, second, and third color element are disposed in a delta-type arrangement. An overlapping portion is formed between two adjacent color elements to serve as a light-blocking area. Each color element is octagonal, having four straight sides and four beveled sides.

### BACKGROUND OF THE INVENTION

1. Field of the Invention

The invention relates to a color filter (CF), and more particularly to a structure of color elements for a color filter. Specifically, the invention is an improvement on a delta-type RGB arrangement to reduce an overlapping area between three adjacent R, G and B elements and reduce an opening area within a non-overlapping portion of three adjacent R, G and B elements, thus promoting color properties, increasing contrast ratio, decreasing light leakage and preventing color mixing.

2. Description of the Related Art

As scientific technologies and information advance, color filters (CF) have been popularly used in video products, such as color liquid crystal displays, and charge coupled devices and scanners, to obtain plentiful color information. With regard to a liquid crystal display (LCD) with light, thin, power-saving and full color features, including super-twisted-nematic (STN) type, thin-film-transistor (TFT) type and metal-insulator-metal (MIM) type, a color filter with three primary colors including red (R), green (G) and blue (B) elements is needed to divide a pixel into R, G and B subpixels. The three primary colors are blended with each other in proportion to create various colors, thus enabling the LCD to display bright, realistic and vivid pictures, enhancing functionality the LCD.

The LCD mainly constitutes a TFT array substrate, a color filter, and a liquid crystal layer. In a conventional CF process, thin-film color layers including R, G and B layers are successively coated on a glass substrate to serve as R elements, G elements and B elements, after which the R, G and B elements must be precisely aligned to pixel areas on the TFT array substrate. In view of manufacturing costs and quality requirements, dyeing, pigment dispersion, printing and electroplating are commonly used to form the R, G and B elements of the color filter. Particularly, pigment dispersion that provides the color filter with high precision and superior light- and heat-resistance has become a major CF process. FIGS. 1A through 1C are top views of trip, mosaic, and delta RGB arrangement types. The delta-type RGB arrangement provides simplified driving and optimum blend-mode effect, and is thus popularly applied to audio/video products. In addition, a black matrix (BM) is disposed between the R, G, and B elements, shielding TFTs on the TFT array substrate from stray light, and preventing light leakage between pixels.

Recently, the BM pattern has been omitted from the CF substrate to decrease process costs, and the light-blocking area replaced by an overlapping portion of adjacent color elements on the CF substrate. FIG. 2A is a top view of a conventional delta-type RGB arrangement with an overlapping portion of adjacent color elements, and FIG. 2B a cross-section of an overlapping portion of three adjacent color elements shown in FIG. 2A. A conventional color filter 10 comprises a plurality of red elements R, green elements G and blue elements B in a delta-type RGB arrangement. Also, an overlapping portion is formed by adjacent color elements to serve as a light-blocking area. However, since each color element has a rectangular profile, an overlapping portion 12 occurs from three adjacent color elements R, G and B. In FIG. 2B, the overlapping portion 12 is a stack of three color coatings, causing non-uniform distribution in pigment (or dye) thickness on a glass substrate. This protrusion damages uniformity of strength of electric fields and rotation of liquid crystal molecules within pixels, resulting in light leakage, decreased contrast ratio, poor color purity and mixed color.

### SUMMARY OF THE INVENTION

Accordingly, an object of the invention is to provide a structure of color elements in a delta-type RGB arrangement for a color filter, in which an overlapping portion of adjacent color elements serves as a light-blocking area. Particularly, for each color element, each corner of a rectangular profile is a faceted profile or a partially-filled pattern to reduce an area of three adjacent color elements overlapping, and reduce an opening area of a non-overlapping portion of three adjacent color elements, thus improving color properties, increasing contrast ratio, reducing light leakage and preventing mixed color.

To achieve these and other advantages, the invention provides a structure of color elements for a color filter with at least a first color element, a second color element and a third color element in a delta-type arrangement. An overlapping portion is formed between two adjacent color elements to serve as a light-blocking area. In one preferred embodiment, each color element is octagonal, having four straight sides and four beveled sides. In another preferred embodiment, each color element has four straight sides and four partially-filled patterns disposed at four corners of an originally rectangular profile.

### DESCRIPTION OF THE DRAWINGS

For a better understanding of the present invention, reference is made to a detailed description to be read in conjunction with the accompanying drawings, in which:

FIGS. 1A through 1C are top views of trip-type, mosaic-type and delta-type RGB arrangements;

FIG. 2A is a top view of a delta-type RGB arrangement with an overlapping portion of adjacent color elements according to the prior art;

FIG. 2B is a cross-section of an overlapping portion of three adjacent color elements shown in FIG. 2A;

FIG. 3A is a top view of three adjacent color elements according to the first embodiment of the present invention;

FIG. 3B is a top view of one color element according to the first embodiment of the present invention;

FIG. 4A is a sectional view along line I-I shown in FIG. 3B to show a thickness profile of the color element;

FIG. 4B is a sectional view along line II-II shown in FIG. 3B to show a thickness profile of the color element;

FIG. 4C is a sectional view along line III-III shown in FIG. 3B to show a thickness profile of the color element;

FIG. 5 is a top view of a color element with a hollowed-out pattern at each corner according to the second embodiment of the present invention; and

FIGS. 6A through 6E are top views of various designs in the partially-filled region according to the second embodiment of the present invention.

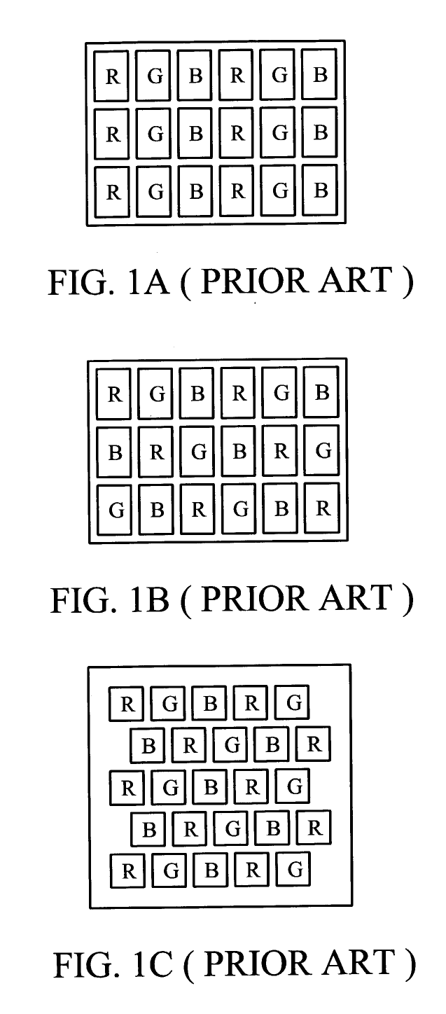

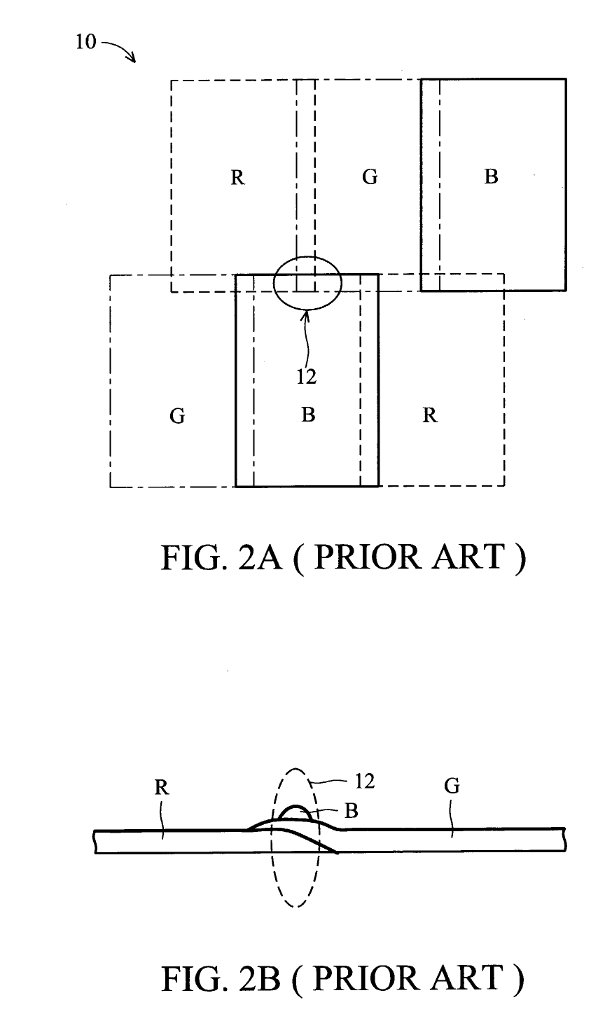

### DETAILED DESCRIPTION OF THE INVENTION

First Embodiment

A first embodiment of the present invention is a color filter with a plurality of R, G and B elements in a delta-type arrangement, in which an overlapping portion is formed between two adjacent color elements to serve as a light-blocking area for replacing a conventional BM process. Also, for each color element, each corner of an originally rectangular profile is shaped as a faceted profile to reduce an area of three adjacent color elements overlapping and reduce an opening area of a non-overlapping portion of three adjacent color elements, thus improving color properties, increasing contrast ratio, reducing light leakage and preventing mixed color.

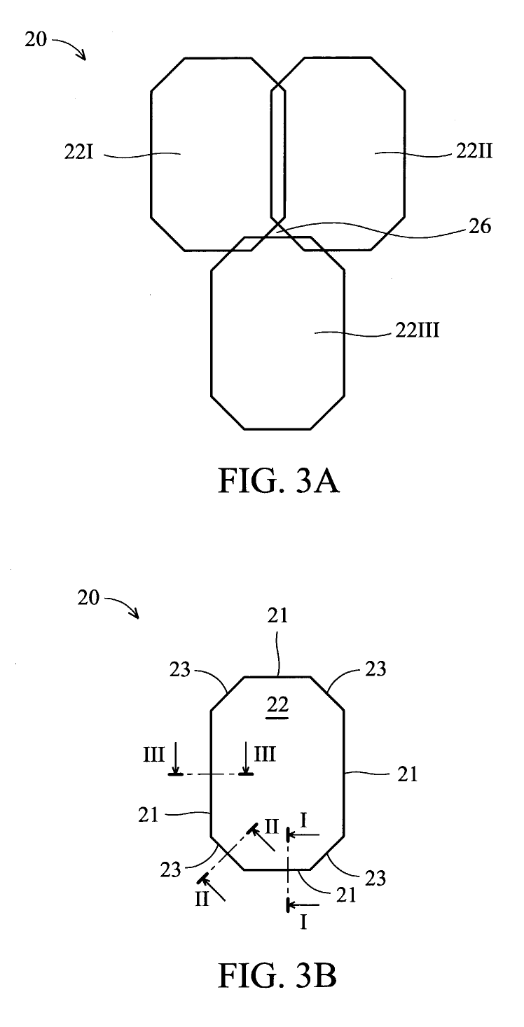

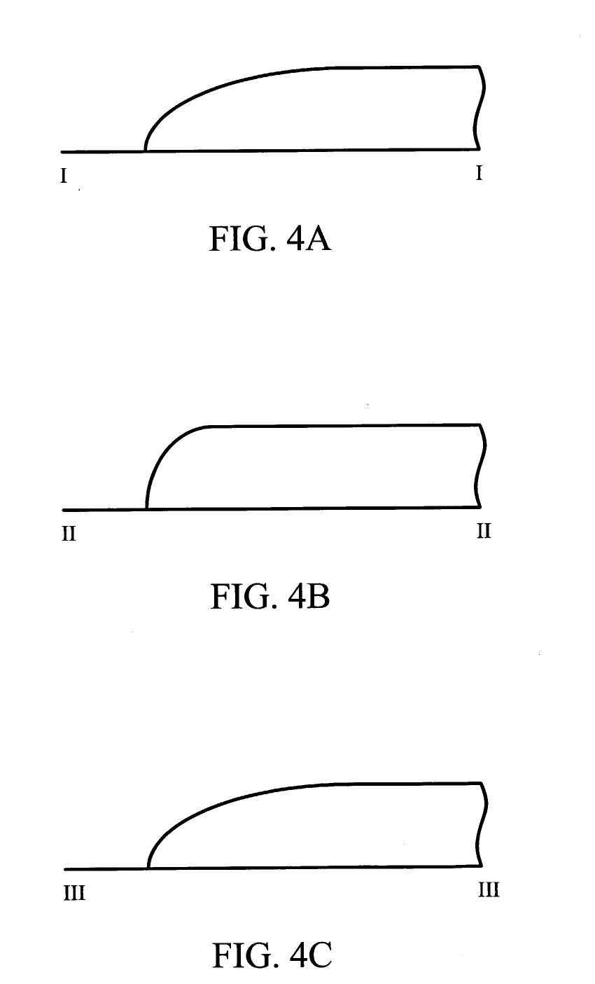

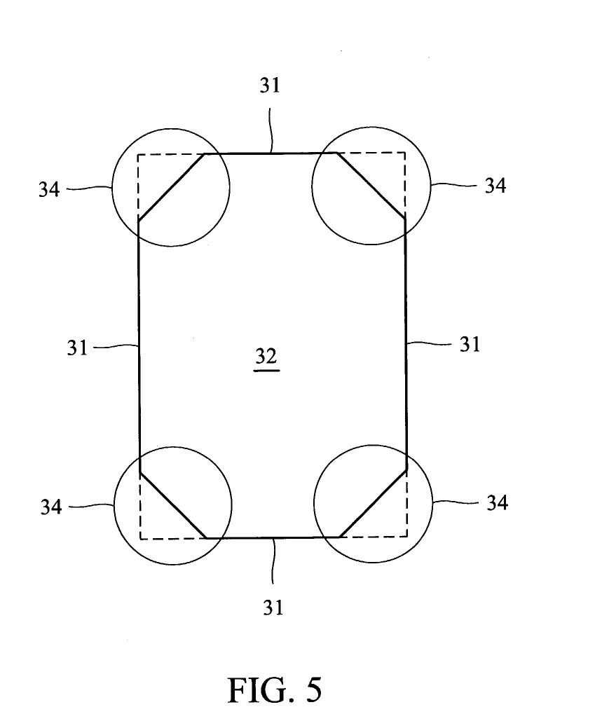

FIG. 3A is a top view of three adjacent color elements according to the first embodiment of the present invention. FIG. 3B is a top view of one color element according to the first embodiment of the present invention. FIG. 4A is a sectional view along line I-I shown in FIG. 3B to show a thickness profile of the color element. FIG. 4B is a sectional view along line II-II shown in FIG. 3B to show a thickness profile of the color element. FIG. 4C is a sectional view along line III-III shown in FIG. 3B to show a thickness profile of the color element.

In FIG. 3A, a color filter 20 comprises three adjacent color elements 22I, 22II and 22III in a delta-type RGB arrangement, with an overlapping portion formed by two adjacent color elements 22 to serve as a light-blocking area. For each color element 22, in FIG. 3B, four corners of an originally rectangular profile have faceted profiles. Thus, the color element 22 is octagonal, having four straight sides 21 and four beveled sides 23. In accordance with the demands of process and color properties, the length of the straight side 21, the length of the beveled side 23 and the inclination of the beveled side 23 can be appropriately modified. Preferably, the length of the beveled side 23 is 0-8 μm, an included angle between the beveled side 23 and the straight side 21 is 0-90°, thus an overlapping range at the rim of each color element 22 is −10˜10 μm. This design prevents a protrusion from a three-layered overlapping at rims of three color elements 22I, 22II and 22III, resulting in improved color properties, increased contrast ratio, reduced light leakage and prevention of mixed color.

However, a small opening 26 may be found in a non-overlapping portion of the three adjacent color elements 22I, 22II and 22III, generating light leakage. To further reduce the area of the opening 26, the peripheral inclination of the pigment at the beveled side 23 must be decreased, for the reasons described hereinafter. When the color elements 22 are patterned by pigment dispersion, dying, printing or electroplating, a surface extension of the pigment (or color resist) causes the pigment at the beveled side 23 to form a steep rim as shown in FIG. 4B. Comparatively, the pigment at the straight side 21 forms a gradual rim as shown in FIGS. 4A and 4C. Thus, when the pigment at the beveled side 23 has a gradual rim, extending range from the gradual rim is increased to decrease the area of the opening 26.

Second Embodiment

The second embodiment of the present invention is an improvement of the corners of an originally rectangular profile of the color elements, in which each corner is a specific partially-filled region including a hollowed-out pattern or a sawtoothed pattern to reduce an overlapping area and an opening area between three adjacent color elements.

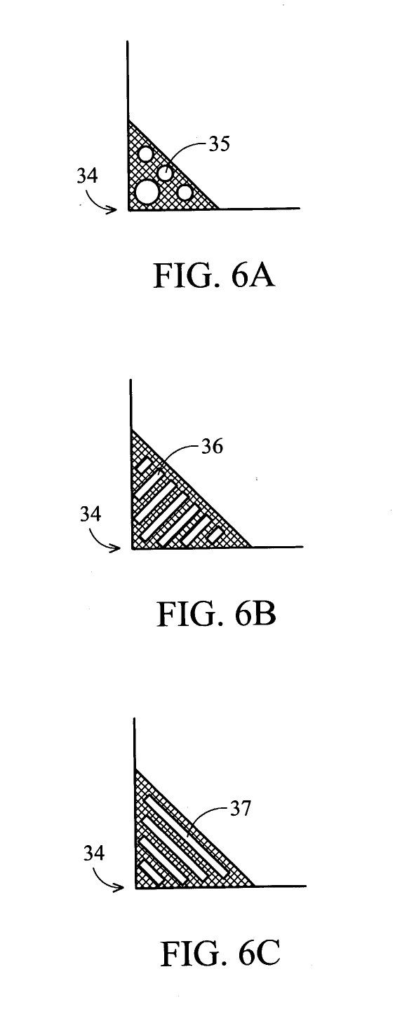

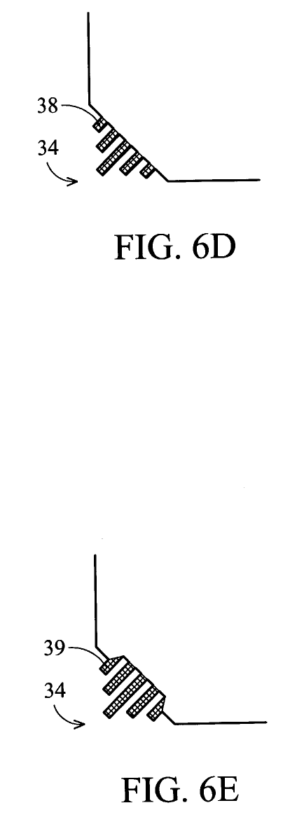

FIG. 5 is a top view of a color element with a hollowed-out pattern at each corner according to the second embodiment of the present invention. FIGS. 6A through 6E are top views of various designs in the partially-filled region according to the second embodiment of the present invention.

In FIG. 5, a color element 32 comprises four straight sides 31 and four partially-filled regions 34 at four corners of an originally rectangular profile. In accordance with the demands of process and color properties, the length of the straight side 31 and the area of the partially-filled region 34 can be appropriately modified.

The partially-filled region 34 is a hollowed-out or sawtoothed pattern, and the four partially-filled regions 34 of the color element 32 are identical, dissimilar, symmetrical or dissymmetrical.

In FIG. 6A, a plurality of circular openings 35 is formed in the partially-filled region 34 to form a first hollowed-out pattern. In FIG. 6B, a plurality of parallel strip-shaped openings 36 extending from upper right to lower left is formed in the partially-filled region 34 to form a second hollowed-out pattern. In FIG. 6C, a plurality of strip-shaped parallel openings 37 extending from upper left toward lower right is formed in the partially-filled region 34 to form a third hollowed-out pattern. Alternatively, any geometric opening can be provided in the partially-filled region 34. The design choices including the profile, area and number of openings is not limited in the second embodiment of the present invention.

In FIG. 6D, a plurality of rectangular strips 38 protruding from a beveled side and arranged parallel at a fixed interval is formed in the partially-filled region 34 to serve as a first sawtoothed pattern. In FIG. 6E, a plurality of rectangular strips 39 protruding from a concave at a beveled side and arranged parallel at different intervals is formed in the partially-filled region 34 to serve as a second sawtoothed pattern. Alternatively, any geometric strips can be provided in the partially-filled region 34. The design choices, including the profile, area, and number and interval of the strips, are not limited in the second embodiment of the present invention.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A structure of color elements for a color filter, comprising:
at least a first color element, a second color element and a third color element in a delta-type arrangement, in which an overlapping portion is formed between two adjacent color elements to serve as a light-blocking area;
wherein each color element is octagonal, having four straight sides and four beveled sides.

2. The structure of color elements for a color filter as claimed in claim 1, wherein a length of the beveled side 0˜8 μm.

3. The structure of color elements for a color filter as claimed in claim 1, wherein an included angle between each beveled side and each straight side is 0-90°.

4. The structure of color elements for a color filter as claimed in claim 1, wherein an overlapping range at the rim of each color element is −10˜10 μm.

5. A structure of color elements for a color filter, comprising:
at least a first color element, a second color element and a third color element in a delta-type arrangement, in which an overlapping portion is formed between two adjacent color elements to serve as a light-blocking area;
wherein each color element comprises four straight sides and four partially-filled regions disposed at four corners of an originally rectangular profile.

6. The structure of color elements for a color filter as claimed in claim 5, wherein the partially-filled region comprises a hollowed-out pattern.

7. The structure of color elements for a color filter as claimed in claim 6, wherein the how-out pattern comprises a plurality of circular openings.

8. The structure of color elements for a color filter as claimed in claim 6, wherein the how-out pattern comprises a plurality of strip-shaped openings.

9. The structure of color elements for a color filter as claimed in claim 5, wherein the partially-filled region comprises a sawtoothed pattern.

10. The structure of color elements for a color filter as claimed in claim 9, wherein the sawtoothed pattern comprises a plurality of inclined strips at a fixed interval.

11. The structure of color elements for a color filter as claimed in claim 9, wherein the sawtoothed pattern comprises a plurality of inclined strips at different intervals.

12. The structure of color elements for a color filter as claimed in claim 9, wherein an overlapping range at the rim of each color element is −10˜10 μm.
